(19) United States
(12) Patent Application Publication
(10) Pub. No.: US 2006/0088392 A1
(43) Pub. Date: Apr. 27, 2006

(54) Multiple bit forming apparatus

(76) Inventor: Steven W. Ciurej, Fort Collins, CO (US)

Correspondence Address: JAMES RAY & ASSOCIATES, 2640 PITCAIRN ROAD, MONROEVILLE, PA, 15146, US

(21) Appl. No.: 11/251,480

(22) Filed: Oct. 14, 2005

Related U.S. Application Data
(60) Provisional application No. 60/621,368, filed on Oct. 23, 2004.

(51) Int. Cl. B23B 39/16

(52) U.S. Cl. 408/53; 408/128

(57) ABSTRACT

An apparatus for forming a plurality of holes in a rigid structure includes a power transmission box having a drive shaft for connection to a spindle of a power drive. A plurality of tool collars are provided, each having a tool shaft rotatably mounted within the housing and coupled to the drive shaft. A base plate is aligned substantially parallel to the side of the box having tool collars. At least one guide shaft maintains the base plate in the substantially parallel relationship. Pluralities of cutting tools are provided, each is secured within a respective tool collar and extends through the guide disposed within the base plate.

### CROSS-REFERENCE TO RELATED APPLICATIONS

This application is related to and claims priory from U.S. Provisional Patent Application Ser. No. 60/621,368 filed Oct. 23, 2004.

### FIELD OF THE INVENTION

The present invention relates, in general, to multiple bit forming devices and, more particularly, this invention relates to multiple bit forming attachments for power driven forming tools and, yet more particularly, the instant invention relates to multiple bit forming attachments for power driven forming tools which are used to drill a plurality of pilot holes for a building door closing device.

### BACKGROUND OF THE INVENTION

It is well known that installation of door hinges, door locks and door closing devices requires forming of a plurality of pilot holes arranged in a predetermined pattern in both the door and the door frame structure. The conventional method of forming such plurality of holes includes marking a reference location for each individual hole using a measuring device and subsequently forming such hole with a stationary tool press or a portable forming tool.

In order to improve efficiency of the installation effort, devices have been utilized which enable simultaneous forming of such plurality of pilot holes.

U.S. Pat. No. 5,085,543 to Click discloses a portable tool attachable to a spindle of the portable power tool. Such portable tool includes a sprocket or a gear box with a plurality of tool collars and a base plate disposed distant from the sprocket box by the guide shafts and springs. A handle is connected to the sprocket or gear box for carrying the tool and for exerting pressure against the sprocket box and the springs during forming.

U.S. Pat. No. 2,706,918 to Blatt discloses a multiple bit attachment for a forming tool which has a split collar attached to a spindle of the power tool and a gear box to tool a pair of pilot holes.

Each prior art reference requires the tool to be held manually during the forming effort and further requires a pressure to be exerted onto the power tool. Such requirements may result in fatigue of a person performing such forming effort leading to decrease in accuracy of the pilot holes particularly when such pilot holes are to be drilled in a door frame header.

Additionally, the location reference for such plurality of pilot holes must be manually measured and marked for each door and door frame.

### SUMMARY OF THE INVENTION

According to one aspect, the invention provides an apparatus for forming a plurality of holes in a rigid structure which includes a housing and a drive shaft rotatably received in one side of the housing, the drive shaft having a first end extending into the housing and a second outwardly extending end for connection to a spindle of a power drive means. Pluralities of tool collars are disposed in a predetermined pattern at another side of the housing, each being one of rigidly coupled to and an extension of a tool shaft which is rotatably mounted within the housing. A power transmission assembly is disposed within the housing and engages the first end of the drive shaft and each of the plurality of tool shafts for transmitting a predetermined torque generated at the drive shaft by such power drive means. A base plate is disposed in a substantially parallel relationship to the other side of the housing having the plurality of tool collars. The base plate has a plurality of tool guides disposed therein, each in substantial axial alignment with a respective one of the plurality of tool collars. At least one guide shaft is rigidly attached to the base plate and movably extends through at least a portion of the housing for maintaining the base plate in the substantially parallel relationship. Pluralities of cutting tools each having a first end secured within a respective one of the plurality of tool collars and a second working end received within a respective one of the tool guides disposed within the base plate.

According to another aspect, the invention provides a support member, an arrangement for movably securing a portable power drive to the support member, whereby a longitudinal axis of a spindle of such portable power drive is aligned with a longitudinal axis of each of such plurality of holes, a multiple cutting tool apparatus having a drive shaft for connection to such spindle of such portable power drive, and an operating mechanism for moving such portable power drive and such multiple cutting tool apparatus in at least one direction for forming such plurality of holes.

### OBJECTS OF THE INVENTION

It is, therefore, one of the primary objects of the present invention to provide a multiple bit forming apparatus for forming a plurality of pilot holes.

Another object of the present invention is to provide a multiple bit forming apparatus for forming a plurality of pilot holes which is attachable to power driven forming devices.

Yet another object of the present invention is to provide a multiple bit forming apparatus for forming a plurality of pilot holes which is usable for mounting door locks and door closing devices.

A further object of the present invention is to provide a multiple bit forming apparatus for forming a plurality of pilot holes which increases the accuracy of the forming effort.

Yet a further object of the present invention is to provide a multiple bit forming apparatus for forming a plurality of pilot holes which does not require the apparatus to be held manually during the forming process.

An additional object of the present invention is to provide a multiple bit forming apparatus for forming a plurality of pilot holes which does not require manual measurement and marking of the location reference for such plurality of pilot holes on each door and door frame.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a perspective view of a multiple forming bit apparatus of the present invention;

FIG. 2 is a perspective view of a multiple forming bit apparatus of the present invention, particularly illustrating support means for use one a door frame, partially illustrated; and

FIG. 3 is a partial perspective view of a multiple forming bit apparatus of the present invention, particularly illustrating attachment to the support means of FIG. 2.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

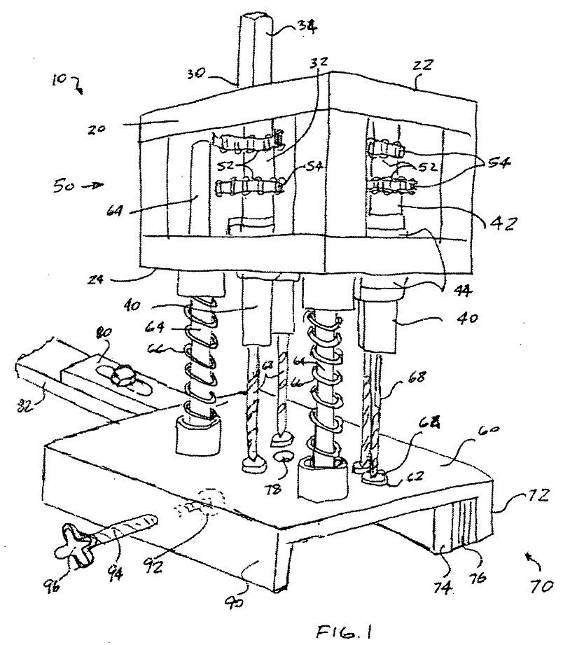

Reference is now made, to FIGS. 1-3, wherein there is shown a multiple bit forming apparatus, generally designated 10, for forming a plurality of holes in a rigid structure 6. In particular reference to FIG. 1, such apparatus includes a housing 20 having a predetermined size and a predetermined shape. A drive shaft 30 is rotatably received in one side 22 of the housing 20 and has a first end 32 extending into the housing 20 and a second outwardly extending end 34 for connection to a spindle 102 of a power drive means 100. The housing 20 may be at least partially open or provided with a cover means 26. A plurality of tool collars 40 are disposed in a predetermined pattern the other side 24 of the housing 20, each being one of rigidly coupled to and an extension of a tool shaft 42 rotatably mounted within the housing 20, preferably with at least one bushing 44 for reducing frictional forces during rotation of such tool shaft 42.

A power transmission means, generally designated 50, is disposed within the housing 20 and engages the first end 32 of the drive shaft 30 and each of the plurality of tool shafts 42 for transmitting a predetermined torque generated at the drive shaft 30 by such power drive means 100.

In a presently preferred embodiment of the invention, the power transmission means 50 is a plurality of sprockets 52, one of which is attached to the first end 32 of the drive shaft 30 and others are attached to each of the plurality of tool shafts 42 and at least one chain 54 engageable with each of the plurality of sprockets 52. An idler shaft (not shown) may be provided for maintaining tension of the at least one chain 54. It will be appreciated that at least a second chain 54 may be provided when the drive shaft 30 and the tool shafts 42 are disposed in a close proximity therebetween.

A base plate 60 is disposed generally parallel to side 24 of the housing 20 which has the plurality of tool collars 40. The base plate 60 has a plurality of tool guide means 62 disposed therein, each in substantially axial alignment with a respective one of the plurality of tool collars 40. Such tool guide means may 62 be an aperture 62 extending through the base plate 60 and substantially equal in size to the size of the forming bit 68 or a tool bushing 64 pressed into the aperture 62 of a pilot type.

At least one and preferably at least two guide shafts 64 maintain the base plate 60 in the substantially parallel relationship. Each guide shaft 64 is rigidly attached to the base plate 60 and movably extends through at least a portion of the housing 20.

Each guide shaft 64 may be surrounded by a spring means 66 which is disposed between the base plate 60 and the side 24 of the housing 20 for urging the base plate 60 and the housing 20 in a direction away from each other.

Pluralities of cutting tools 68 each having a first end secured within a respective one of the plurality of tool collars 40 and a second end received within a respective one of the tool guide means 62 disposed within the base plate 60 are provided for forming such holes. The cutting tools 68 may be of an identical or various sizes.

Furthermore, It will be appreciated that the cutting tool 68 may be of a drill type forming a pilot hole within the rigid structure 6 or of a tap type forming a threaded hole in the rigid structure 6.

In a further reference to FIG. 1, there is a means, generally designated 70, engageable with the base plate 60 and with rigid structure 6 for aligning the plurality of tool guide means 62 in at least a first direction within a predetermined portion of the rigid structure 6.

Such alignment means 70 may be a simple outwardly extending lip 72 attached to one end of the base plate 60 and which is at least partially extending along such end of the base plate 60. Preferably, such alignment means 70 further includes a member 74 disposed substantially parallel to the lip 72 and spaced therefrom with at least one shim member 76. It will be appreciated that such at least one shim member 76 enables adjustable alignment of the plurality of tool guide means 62 to accommodate dimensional variations of the rigid structure 6. The member 74 and the least one shim member 76 may be attached to the lip 72 with any well known fasteners (not shown).

Alternatively, an aperture 78 may be disposed in a predetermined portion of the base plate 60 for alignment with a reference mark formed within such rigid structure 6. Advantageously, such aperture 78 may be used in combination with the lip 72 and member 74 to align the plurality of tool guide means 62 in a second direction.

Alternatively, the alignment means 70 may include means for aligning the plurality of tool guide means 62 in a second direction within such predetermined portion of such rigid structure 6, such as a pair of adjustably disposed elongated members 80 and 82 engageable with the base plate 60 and with such rigid structure 6.

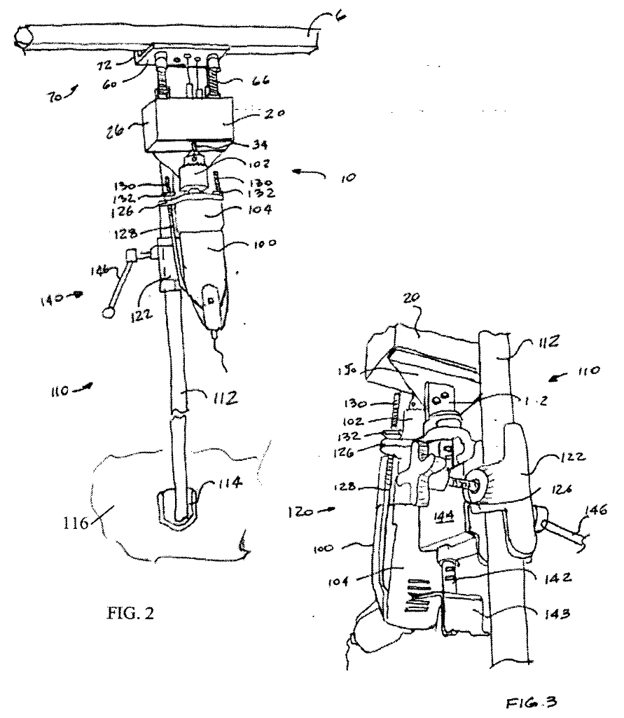

In operation, to form a plurality of holes, the apparatus 10 is coupled to the power drive means 100, best shown in FIGS. 2-3, by clamping the second end 34 of the drive shaft 30 within the spindle 102 of such power drive means 100. The base plate 60 is engaged with such predetermined portion of the rigid structure 6 and a manual force is applied to the power drive means 100 causing engagement of the plurality of cutting tools 68 with such rigid structure 6. The manual force is maintained during the forming effort. When the forming effort is completed, the direction of the manual force is reversed to disengage the plurality of cutting tools 68 from the rigid structure 6. It has been found that the reversal of the manual force is sufficient to disengage the plurality of cutting tools 68 from the rigid structure 6 absent the spring means 66.

The power drive means 100 may be a well known stationary press type when the rigid structure 6 is easily transported to and from such stationary press 100 or the power drive means 100 may be of a portable type for use on a stationary rigid structure 6, such as a door frame header illustrated in FIG. 2.

Advantageously, the base plate may be provided with a second lip 90 opposing the first lip 72 for caging such rigid stationary structure 6 therebetween. A clamp means 92 is then provided for removably securing such apparatus 10 onto the rigid structure 6. Such clamp means 92 may be any independent well known clamp type (not shown) or may be adapted with a threaded elongated member 94 threadedly received within the second lip 90 and a simple knob 96 for exerting a manual pressure onto such clamp means 92.

Those skilled in the art will readily understand that utilization of the clamp means 92 eliminates manual holding of the apparatus 10 during the forming effort, therefore reducing fatigue and increasing the accuracy of the forming effort.

In another embodiment of the invention, the apparatus 10 may be provided with a support means, generally designated 110, preferably being of a transportable stationary type, and means, generally designated 120, for securing such power drive 100 of a portable type to the support means 100, whereby a longitudinal axis of such spindle 102 of such portable power drive 100 is aligned with longitudinal axis of each of such plurality of pilot holes. In the presently preferred embodiment of the invention, such support means 110 includes an elongated member 112 rigidly attached to a base means 114 for engagement with a stationary rigid surface 116, such as a floor 116. In such embodiment, the elongated member 112 is substantially vertically disposed enabling ease of forming the plurality of holes in the horizontally disposed door frame header 6 of FIG. 2.

Alternatively, the elongated member 112 may be adapted with a clamp means 92 for attachment to and suspension from such horizontally disposed door frame header 6. Further, the support means 110 may be attached to base plate 60 having the clamp means 92. Additionally, the support means 110 may be removably attached to the door frame vertical members (not shown).

The means 120 for coupling such portable power drive 100 to the support means 110 includes a clamp means 122 engageable with the elongated member 112 and a simple knob 124 with a threaded stem 126 for securing such clamp means 122 to a predetermined portion of the elongated member 112. A collar 126 is provided for engagement with a portion of the housing 102 of the power drive means 100 which is disposed adjacent the spindle 102. An elongated member 128, shown in FIGS. 2-3, is formed by bending, approximately in its mid section, to surround the back portion of the housing 104 and has threaded ends 130 engaging the opposed portions of the collar 126. A pair of nuts 132 disposed at the threaded ends 130 and engageable with the surface of the collar 126 are utilized to exert a force onto the collar 126 and cage the housing 104 between such collar 126 and the formed section of the elongated member 128 for securing the power drive means 100 to the support means 110.

The elongated member 128 is preferably of a rigid type, such as a rigid wire, enabling bending thereof and of a predetermined diameter sufficient to thread its ends 130. Alternatively, a flexible elongated member 126, such as a strap or a flexible wire may be utilized to secure the drive means 100 to the support means 110.

The apparatus 10 further includes an operating means, generally designated 140, engageable with the coupling means 120 for moving such portable power drive 100 and for forming such plurality of pilot holes in such rigid member 6. The operating means 140 includes a rack 142 having a longitudinal axis aligned coaxially with a longitudinal axis of such spindle 102 and having one end attached to the collar 126, means 143 engageable with the housing 104 for aligning it with the longitudinal axis of the spindle 102, and a support member 134 which is attached to the clamp means 122. The operating means 140 further includes a handle 146 rotatably connected to the support member 144, a pinion (not shown) engageable with the rack 142 and attached to the handle 146 for rotation therewith. It will be appreciated that a manual rotation of the handle 146 in one direction causes linear movement of the rack 142 and further causes linear movement of such portable power drive 100 and the plurality of cutting tools 68 towards such rigid structure for forming such plurality of pilot holes. When the forming effort has been completed, the rotation of the handle is reversed disengaging the plurality of cutting tools 68 from the rigid structure 6. Although not required, such disengagement of the plurality of tool bits 68 from the rigid structure 6 may be further aided by use of the springs means 66.

A rigid connection between the collar 126 and the housing 20 may be provided via a bracket 150 attached to the housing 20 and a second bracket 152 coupled to the rack 132 and which are rigidly connected therebetween.

Although the present invention has been shown in terms of the power transmission means utilizing a plurality of sprockets 52 and at least one chain 54, it will be apparent to those skilled in the art, that the present invention may utilize other well known power transmission means. For example, a plurality of pulleys one of which is attached to the drive shaft 30 and others are attached to each of the plurality of tool shafts 42 may be used in combination with at least one belt engageable with each of the plurality of pulleys. Alternatively, a plurality of gears engageable therebetween, one of which is attached to the drive shaft 30 and others are attached to each of the plurality of tool shafts 42 may be utilized to transfer the torque generated at the drive shaft 30 to each of the plurality of tool shafts 42.

The rack and pinion arrangement of the present invention may be replaced by any other well known arrangement providing for a linear motion. For example, a lead screw and a nut may be used eliminating the need for the manual actuation handle.

Alternatively, a power linear drive, such as a cylinder or an electric motor attached to one end of the lead screw may be utilized to move the portable power drive 100 for forming holes in the rigid structure 6.

Furthermore, the coupling means 130 or the clamp means 120 may be adapted with a tilting or swivel mechanism to align the spindle 102 of the portable power drive 100 in a predetermined direction, for example such as a horizontal direction.

Those skilled in the art will readily understand that the coupling means 120 discussed supra are advantageous for use with the existing portable power drive means 100. Alternatively, the housing 104 of a newly manufactured portable drive means 100 may be adapted with the collar 126 and the aligning means 143 for attachably receiving the rack 142.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. An apparatus for forming a plurality of holes in a rigid structure, said apparatus comprising:
(a) a housing;
(b) a drive shaft rotatably received in a first side of said housing, said drive shaft having a first end extending into said housing and a second outwardly extending end for connection to a spindle of a power drive means;
(c) a plurality of tool collars disposed in a predetermined pattern at a second side of said housing, each being one of rigidly coupled to and an extension of a tool shaft rotatably mounted within said housing;
(d) a power transmission means disposed within said housing and engaging said first end of said drive shaft and each of said plurality of tool shafts for transmitting a predetermined torque generated at said drive shaft by such power drive means;
(e) a base plate disposed substantially parallel to said second side of said housing having said plurality of tool collars, said base plate having a plurality of tool guide means disposed therein, each in substantial axial alignment with a respective one of said plurality of tool collars;
(f) at least one guide shaft rigidly attached to said base plate and movably extending through at least a portion of said housing for maintaining said base plate in said substantially parallel relationship; and
(g) a plurality of cutting tools each having a first end secured within a respective one of said plurality of tool collars and a second working end received within a respective one of said tool guide means disposed within said base plate.

2. The apparatus, according to claim 1, wherein said power transmission means is a plurality of sprockets one of which is attached to said first end of said drive shaft and others are attached to each of said plurality of tool shafts and at least one chain engageable with each of said plurality of sprockets.

3. The apparatus, according to claim 1, wherein said power transmission means is a plurality of pulleys one of which is attached to said first end of said drive shaft and others are attached to each of said plurality of tool shafts and at least one belt engageable with each of said plurality of pulleys.

4. The apparatus, according to claim 1, wherein said power transmission means is a plurality of gears engageable therebetween, one of which is attached to said first end of said drive shaft and others are attached to each of said plurality of tool shafts.

5. The apparatus, according to claim 1, wherein said apparatus includes means engageable with said base plate and with such rigid structure for aligning said plurality of tool guide means disposed within said base plate in at least a first direction within a predetermined portion of such rigid structure.

6. The apparatus, according to claim 5, wherein said alignment means is an outwardly extending rigid member being one of attached and integral to said base plate and abutting a portion of such rigid structure.

7. The apparatus, according to claim 6, wherein said alignment means further includes at least one shim and a second rigid member for adjustably aligning said plurality of tool guide means disposed within said base plate to such portion of such rigid structure.

8. The apparatus, according to claim 5, wherein said alignment means is an aperture disposed in a predetermined portion of said base plate for alignment with a reference mark formed within such rigid structure.

9. The apparatus, according to claim 5, wherein said apparatus includes a second alignment means engageable with said base plate and with such rigid structure for aligning said plurality of tool guide means disposed within said base plate in a second direction within such predetermined portion of such rigid structure.

10. The apparatus, according to claim 1, wherein said apparatus further includes a clamp means for removably securing said base plate to such rigid structure.

11. The apparatus, according to claim 1, wherein such power drive means is a portable power drive and said apparatus further includes a support means and means for movably securing such portable power drive to said support means, whereby a longitudinal axis of a spindle of such portable power drive is aligned with a longitudinal axis of each of such plurality of holes.

12. The apparatus, according to claim 11, wherein said support means includes a substantially vertically disposed elongated member rigidly attached to a base means.

13. The apparatus, according to claim 11, wherein said support means includes a clamp means for removably attaching said support means to such rigid structure.

14. The apparatus, according to claim 11, wherein said means for movably securing such portable power drive to said support means includes a second clamp means engageable with said support means.

15. The apparatus, according to claim 11, wherein said apparatus further includes an operating means engageable with said securing means for moving such portable power drive and for forming such plurality of holes in such rigid member.

16. The apparatus, according to claim 15, wherein said operating means includes a rack attached to said securing means and having a longitudinal axis aligned coaxially with a longitudinal axis of such spindle, means engageable with a housing of such portable power drive for aligning said rack, a support member attached to said clamp means, a handle rotatably connected to said support member, a pinion engageable with said rack and attached to said handle for rotation therewith, whereby a manual rotation of said handle in one direction causes linear movement of said rack and further causes linear movement of such portable power drive and said plurality of cutting tools towards such rigid structure for forming such plurality of holes.

17. The apparatus, according to claim 1, wherein each of such plurality of holes is one of a pilot and threaded.

18. An apparatus for forming a plurality of holes with a portable power drive in a rigid structure, said apparatus comprising:
(a) a rack having a longitudinal axis aligned coaxially with a longitudinal axis of such spindle;
(b) means for rigidly attaching said rack to a housing of such portable power drive;
(c) an operating means having a support member, a handle rotatably connected to said support member, a pinion engageable with said rack and attached to said handle for rotation therewith, and a clamp means disposed at one end of support member; and
(d) a multiple cutting tool device having a drive shaft for connection to such spindle of such portable power drive.

19. An apparatus for forming a plurality of holes with a portable power drive in one of a door and a door frame for mounting one of a lock and a door closing device, said apparatus comprising:
(a) a support means;
(b) means for movably securing such portable power drive to said support means, whereby a longitudinal axis of a spindle of such portable power drive is aligned with a longitudinal axis of each of such plurality of holes;
(c) multiple cutting tool apparatus having a drive shaft for connection to such spindle of such portable power drive; and
(d) an operating means for moving such portable power drive in at least one direction for forming such plurality of holes.

20. The apparatus, according to claim 19, wherein said operating means includes:
(a) a rack having a longitudinal axis aligned coaxially with a longitudinal axis of such spindle;
(b) means for rigidly attaching said rack to a housing of such portable power drive;
(c) a support member;
(d) a handle rotatably connected to said support member; and
(e) a pinion engageable with said rack and attached to said handle for rotation therewith, whereby a manual rotation of said handle in one direction causes linear movement of said rack and further causes linear movement of such portable power drive and said multiple cutting tooling apparatus for forming such plurality of holes.
